(19) United States
(12) Patent Application Publication
(10) Pub. No.: US 2009/0027358 A1
(43) Pub. Date: Jan. 29, 2009

(54) Input display apparatus and input display panel

(75) Inventor: Masafumi hosono, Kunitachi-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 12/069,110

(22) Filed: Feb. 7, 2008

(30) Foreign Application Priority Data
Jul. 26, 2007 (JP) 2007-194828

(51) Int. Cl. G06F 3/042

(52) U.S. Cl. 345/175

(57) ABSTRACT

Besides a white LED employed as a general backlight, an Ir-LED is provided to apply an infrared light beam from a display face of an input display panel to the outside, reflected light of the infrared light beam is detected by a sensor, and a user's request is thereby accepted.

### CROSS-REFERENCE TO RELATED APPLICATIONS

This application is based upon and claims the benefit of priority from prior Japanese Patent Application No. 2007-194828, filed Jul. 26, 2007, the entire contents of which are incorporated herein by reference.

### BACKGROUND OF THE INVENTION

1. Field of the Invention

The present invention relates to an input display apparatus having an input device and a display device unified therein.

2. Description of the Related Art

A display device comprising an inputting function detects an input in a resistance film system or a capacitance system. Recently, the circuitry has been miniaturized and an optical system of aligning light sensors on a glass substrate of the display device and detecting the input by the light sensors has been developed (cf., for example, Jpn. Pat. Appln. KOKAI Publication No. 2006-238053).

In the optical system, a shadow of a finger formed on the display device is detected by a light sensor, or a light beam emitted from the display device and reflected on a finger is detected by a light sensor, and a user's request is discriminated in accordance with a position of arrangement of the light sensor.

However, this optical system has a problem that stable detection cannot be executed if the degree of illumination of the environment light is low or images are dark. In addition, complicated control to adjust the detection accuracy in accordance with ambient brightness and the change of displayed images is required.

The input display apparatus of the conventional optical system has a problem that stable detection cannot be executed if the degree of illumination of the environment light is low, images are changed or images are dark.

### BRIEF SUMMARY OF THE INVENTION

The present invention has been accomplished to solve the above-described problems. The object of the present invention is to provide an input display apparatus and input display panel, capable of stably executing input detection, irrespective of the illumination of the environment light, change of the images or brightness of the images.

To achieve this object, an aspect of the present invention is an input display apparatus comprising: an input display unit in which a plurality of light emitting units emitting light beams of a plurality of colors and a plurality of sensors sensing an infrared light beam are arranged, a display control unit which controls the colors of the light beams emitted by the light emitting units to urge the input display unit to display an image, and an input detecting unit which detects an input in accordance with a result of detection of the sensors.

According to the present invention, a plurality of light emitting units emitting light beams of a plurality of colors and a plurality of sensors sensing infrared light are arranged, the colors of the light beams emitted by the light emitting units are controlled to urge the input display unit to display an image, and the input is detected on the basis of the result of detection of the sensors.

Therefore, since the infrared light emitted from, for example, a stylus or the like is detected and the input is accepted on a display face of the image, input detection can be stably executed, irrespective of the illumination of the environment light, change of the images or brightness of the images.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is an illustration showing a structure of an input display apparatus according to an embodiment of the present invention;

FIG. 2 is an illustration showing a structure of an input display panel of the input display apparatus shown in FIG. 1; and

FIG. 3 is an illustration in a case where Ir-LED is provided on an outer periphery of a protective layer as a sidelight.

### DETAILED DESCRIPTION OF THE INVENTION

An embodiment of the present invention will be described below with reference to the accompanying drawings.

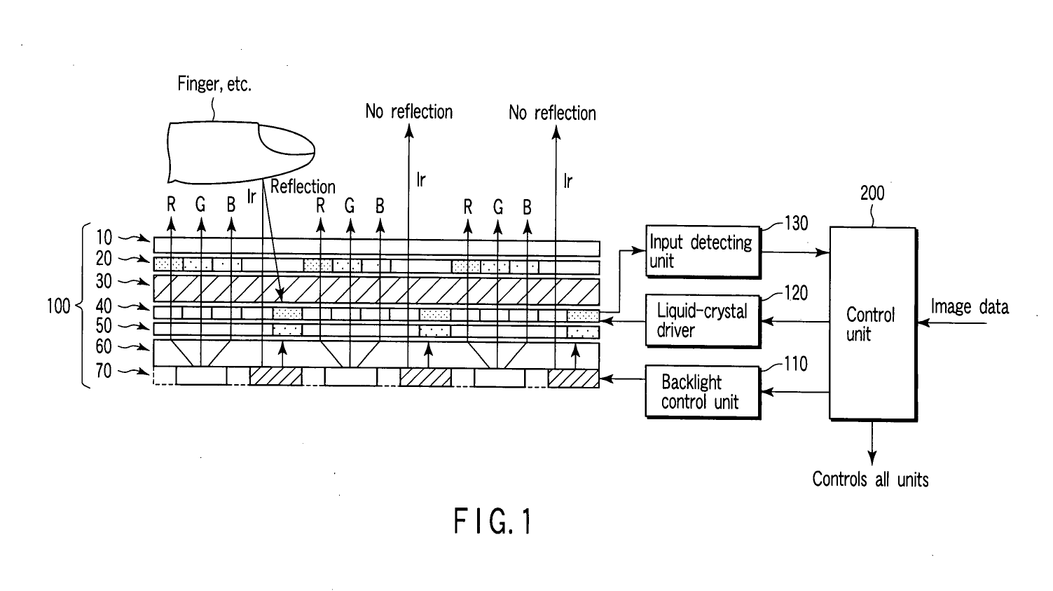

FIG. 1 shows a structure of an input display apparatus according to an embodiment of the present invention. The input display apparatus comprises an input display panel 100, a backlight control unit 110, a liquid-crystal driver 120, an input detection unit 130 and a control unit 200.

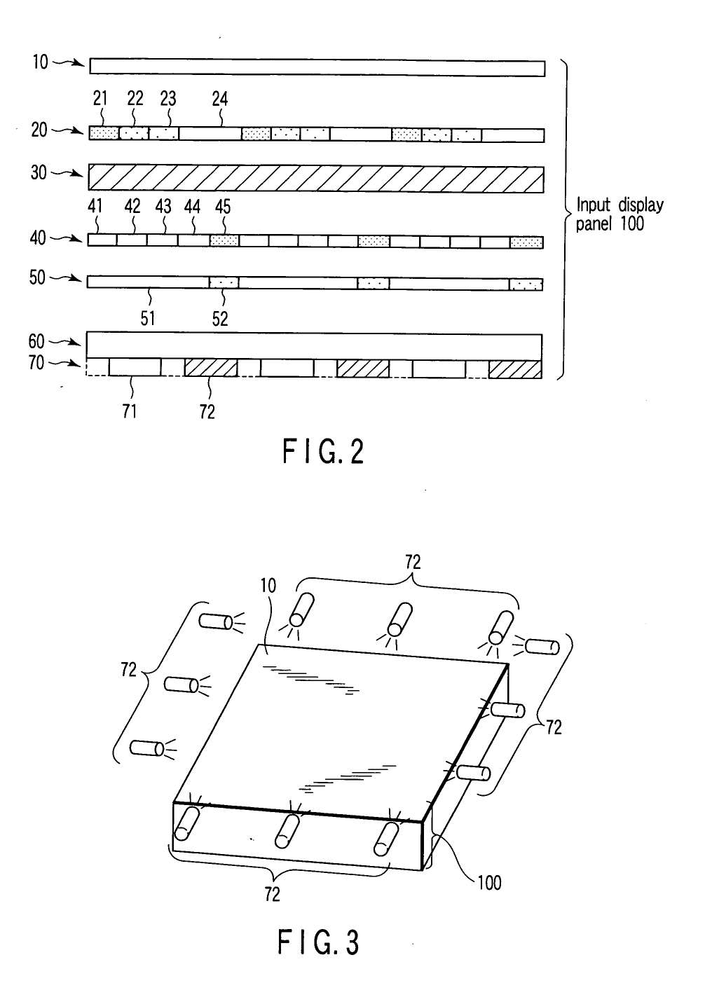

The input display panel 100 has a multilayered structure as shown in FIG. 2, and comprises a protective layer 10, a filter layer 20, a liquid-crystal layer 30, a TFT (Thin Film Transistor) layer 40, a substrate layer 50, a light guiding plate layer 60 and a backlight layer 70.

The protective layer 10 is configured to protect the input display panel 100 from an outer pressure and is formed of a transparent and hard resin material such as acryl or the like. The protective layer 10 plays roles of polarization, prevention of reflection and the like besides the protection.

In the filter layer 20, filters 21, 22, 23, 24 which allow the light beams of wavelengths of the three primary colors (Red, Green, Blue) of light and the infrared light beam (Ir; infrared light) to pass therethrough, respectively, are arranged regularly.

The filter 21 allows the only wavelength of the red visible light to pass therethrough. The filter 22 allows the only wavelength of the green visible light to pass therethrough. The filter 23 allows the only wavelength of the blue visible light to pass therethrough. The filter 24 allows the only wavelength of the infrared light to pass therethrough.

In the liquid-crystal layer 30, alignment of the liquid-crystal molecules is changed and the light transmission/non-transmission is controlled, by voltage to be applied from the TFT layer 40 to be described later.

The TFT layer 40 is configured to apply the voltage to the liquid-crystal layer 30. A number of active elements (transistors) corresponding to the pixels are arranged in matrix in the TFT layer 40. The TFT layer 40 comprises active elements 41 configured to output the red visible light, active elements 42 configured to output the green visible light, active elements 43 configured to output the blue visible light and active elements 44 configured to output the infrared light, besides sensors 45 configured to receive and detect the infrared light.

The substrate layer 50 configured to stably support the TFT layer, comprises a transparent unit 51 which is formed of a material such as glass or the like and allows the light to pass therethrough and a nontransparent layer 52 which is arranged at a position corresponding to the sensor 45 and does not allow the light to pass therethrough.

The light guiding plate layer 60 is formed of a material such as acryl or the like, having high transparency, to guide the light emitted from the backlight layer 70 to the TFT layer through the substrate layer 50.

The backlight layer 70 plays a role of a light source. In the backlight layer 70, white LED (Light Emitting Diode) 71 and Ir-LED 72 emitting the infrared light are arranged alternately and regularly.

The backlight control unit 110 controls each of the white LED 71 and the Ir-LED 72 to be ON/OFF in accordance with an instruction from the control unit 200.

The liquid-crystal driver 120 controls the active elements 41 to 44 provided in the TFT layer 40 to be ON/OFF in accordance with an image signal supplied from the control unit 200.

The input detection unit 130 collects the result of detecting the infrared light by the sensor 45 provided in the TFT layer 40 and notifies the control unit 200 of detection coordinate information representing the position of the sensor 45 that has detected the infrared light.

The control unit 200 comprises a display control function of displaying the image based on the image data to the user by the input display panel 100, and an input control function of detecting the user's request from a position of the user's finger which covers the surface of the input display panel 100. The display control function converts the image data into an image signal which can be interpreted by the liquid-crystal driver 120 and outputs the converted image signal to the liquid-crystal driver 120. The input control function detects the user's request from the detection coordinate information input from the input detection unit 130 and the information represented by the image based on the image data, and controls a control block (not shown) (for example, a sounder, a communications unit, an image processing unit or the like) in response to this request.

Next, operations of the input display apparatus having the above-described configuration will be described with reference to FIG. 1.

First, the control unit 200 converts the image data into the image signal which can be interpreted by the liquid-crystal driver 120, outputs the converted image signal to the liquid-crystal driver 120, and instructs the backlight control unit 110 to control the white LED 71 to be ON, as the control to display the image based o the image data to the user by the input display panel 100.

The backlight control unit 110 controls the white LED 71 to be ON, and the white LED 71 thereby emits the white light. On the other hand, the liquid-crystal driver 120 controls the active elements 41 to 43 provided in the TFT layer 40 to be ON/OFF, in response to the image signal supplied from the control unit 200. In the liquid-crystal layer 30, the alignment of the liquid-crystal molecules is thereby changed and the light transparency/non-transparency is controlled.

The white light emitted from the white LED 71 passes through the light guiding plate layer 60, the substrate layer 50, and the active elements 41 to 43, and also passes through the only portion controlled to be transparent by the active elements 41 to 43, of the liquid-crystal layer 30. The white light thus passing through the liquid-crystal layer 30 passes through the filter layer 20 such that the only wavelength of red, green or blue visible light passes therethrough and the image is displayed on the entire input display panel 100 through the protective layer 10, to the user.

When the control unit 200 executes the input control, the control unit 200 first instructs the liquid-crystal driver 120 to allow the infrared light to pass therethrough and instructs the backlight control unit 110 to control the Ir-LED 72 to be ON.

The backlight control unit 110 controls the Ir-LED 72 to be ON such that the Ir-LED 72 emits the infrared light. The liquid-crystal driver 120 controls the active element 44 provided in the TFT layer 40 to be ON in accordance with the instruction supplied from the control unit 200. The alignment of the liquid-crystal molecules in the liquid-crystal layer 30 is thereby changed such that the liquid-crystal layer 30 is controlled to allow the light to pass therethrough.

Then, the infrared light emitted from the Ir-LED 72 passes through the light guiding plate layer 60, the substrate layer 50, the active element 44, the liquid-crystal layer 30 corresponding to the active element 44, the filter 24, and the protective layer 10, in the order, and is emitted to the outside of the input display panel.

The infrared light thus emitted to the outside reflects on an obstacle such as a finger, a stylus, or the like.

When the obstacle is located in the vicinity of the protective layer 10, the reflected infrared light passes through the protective layer 10, the filter 24 and the liquid-crystal layer 30, and reaches and illuminates the sensor 45. The sensor 45 detects the input of the infrared light and notifies the input detection unit 130 of the input of the infrared light.

The input detection unit 130 collects the result of detection of the infrared light by the sensor 45 provided in the TFT layer 40 and notifies the filter layer 20 of the detected coordinate information representing the position of the sensor 45 which has detected the infrared light. Then, the control unit 200 detects the user's request on the basis of the detected coordinate information input from the input detection unit 130 and the information represented by the image based on the image data, and controls the function blocks (not shown) (for example, a sounder, a communications unit, an image processing unit and the like) in response to the user's request.

In the input display apparatus having the above-described configuration, the Ir-LED 72 is provided besides the white LED 71 employed as the general backlight, to apply the infrared light to the outside from the display face of the input display panel 100, detect the infrared light by the sensor 45 and accept the user's request.

Therefore, since the infrared light is used to detect the user's request from the reflected light thereof, the input detection can be executed stably irrespective of the illumination of the environmental light, change of the image, brightness of the image, and the like.

The present invention is not limited to the embodiments described above but the constituent elements of the invention can be modified in various manners without departing from the spirit and scope of the invention. Various aspects of the invention can also be extracted from any appropriate combination of a plurality of constituent elements disclosed in the embodiments. Some constituent elements may be deleted in all of the constituent elements disclosed in the embodiments. The constituent elements described in different embodiments may be combined arbitrarily.

The white LED 71 employed as a general backlight and the Ir-LED 72 are arranged side by side on the same plane of the display face of the input display panel 100, in the above-described embodiment. However, the present invention is not limited to this. For example, the Ir-LED 72 may be arranged at a position which is not in the shade of the sensor 45 of the filter 24 or arranged between the protective layer 10 and the filter layer 20. Otherwise, the Ir-LED 72 may be provided, as a sidelight, on the outer periphery on the protective layer 10 (i.e. on the display face of the input display panel 100) as shown in FIG. 3.

The sensor 45 is provided on the same plane as the TFT layer 40 between the liquid-crystal layer 30 and the substrate layer 50, but may be provided on the filter layer 20. The Ir-LED 72 is provided as the light source of the infrared light. Instead of this, a stylus emitting the infrared light from a tip thereof can be employed.

Furthermore, the present invention can also be applied to a display panel of organic EL (Electro Luminescence) or the like. In this case, since the display panel emits light, the filter layer 20, the liquid-crystal layer 30, the light guiding plate layer 60 and the backlight layer 70 are not required, but the sensor 45 is provided to detect the infrared light emitted from the organic EL display panel or the infrared light emitted from the stylus.

The control unit 200 detects the user's input on the basis of the detected coordinate information input from the input detection unit 130. Instead of this, however, the input detection unit 130 may obtain a difference (or distribution) between levels of the infrared light detected by the respective sensors 45 and detect a portion where the obtained difference represents a maximum value (or a central portion of the distribution) as the input position. According to this, an error in detection of the infrared light present in the natural world can be prevented.

In addition, the user's request is discriminated from the existence and position of an obstacle such as a finger, and the displayed image. However, the fingerprint pattern and intravenous pattern of the user may be scanned by a number of sensors 45 arranged in a high density, and occurrence of the user's request may be detected by collating the detected patterns with preliminarily registered patterns.

Otherwise, the present invention can be variously modified within a scope which does not depart from the gist of the present invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An input display apparatus, comprising:
an input display unit in which a plurality of light emitting units emitting light beams of a plurality of colors and a plurality of sensors sensing an infrared light beam are arranged;
a display control unit which controls the colors of the light beams emitted by the light emitting units to urge the input display unit to display an image; and
an input detecting unit which detects an input in accordance with a result of detection of the sensors.

2. The apparatus according to claim 1, wherein the input display unit has the plurality of light emitting units and the plurality of sensors regularly arranged therein.

3. The apparatus according to claim 2, wherein each of the light emitting units comprises:
a light outputting unit which emits visible light beams of a plurality of wavelengths;
a filter unit which allows the visible light beams of a plurality of wavelengths different from each other to pass therethrough; and
a shutter unit which controls the light passage by a liquid-crystal shutter.

4. The apparatus according to claim 1, wherein the input detecting unit detects the input from a difference between detection levels of the plurality of sensors.

5. An input display apparatus, comprising:
an infrared light outputting unit which outputs an infrared light beam;
an input display unit in which a plurality of light emitting units emitting light beams of a plurality of colors and a plurality of sensors sensing reflected light of the infrared light beam output from the infrared light outputting unit are arranged;
a display control unit which controls the colors of the light beams emitted by the light emitting units to urge the input display unit to display an image; and
an input detecting unit which detects an input in accordance with a result of detection of the sensors.

6. The apparatus according to claim 5, wherein the input display unit has the plurality of light emitting units and sensors, and a plurality of infrared light outputting units identical with the infrared light outputting unit regularly arranged therein.

7. The apparatus according to claim 6, wherein each of the light emitting units comprises:
a light outputting unit which emits visible light beams of a plurality of wavelengths;
a filter unit which allows the visible light beams of a plurality of wavelengths different from each other to pass therethrough; and
a shutter unit which controls the light passage by a liquid-crystal shutter.

8. The apparatus according to claim 5, wherein the infrared light outputting unit is arranged on an outer periphery of a display face on which the input display unit displays the image.

9. The apparatus according to claim 5, wherein the input detecting unit detects the input from a difference between detection levels of the plurality of sensors.

10. An input display panel, comprising:
a light emitting unit which emits light beams of a plurality of colors; and
a sensor arranged side by side with the light emitting unit on a same plane to sense infrared light.

11. The panel according to claim 10, wherein a plurality of light emitting units identical with the light emitting unit and a plurality of sensors identical with the sensor are regularly arranged on the same plane.

12. The panel according to claim 10, wherein the light emitting unit comprises:
a light outputting unit which emits visible light beams of a plurality of wavelengths;
a filter unit which allows the visible light beams of a plurality of wavelengths different from each other to pass therethrough; and
a shutter unit which controls the light passage by a liquid-crystal shutter.

13. An input display panel, comprising:
an infrared light outputting unit which outputs an infrared light beam;
a light emitting unit which emits light beams of a plurality of colors; and
a sensor arranged side by side with the light emitting unit on a same plane to sense reflected light of the infrared light beam output from the infrared light outputting unit.

14. The panel according to claim 13, wherein a plurality of light emitting units identical with the light emitting unit and a plurality of sensors identical with the sensor are regularly arranged on the same plane.

15. The panel according to claim 13, wherein the light emitting unit comprises:
a light outputting unit which emits visible light beams of a plurality of wavelengths;
a filter unit which allows the visible light beams of a plurality of wavelengths different from each other to pass therethrough; and
a shutter unit which controls the light passage by a liquid-crystal shutter.
